(19) United States
(12) Patent Application Publication
(10) Pub. No.: US 2023/0390946 A1
(43) Pub. Date: Dec. 7, 2023

(54) POSITIONING APPARATUS AND METHOD FOR POSITIONING A FLEXIBLE, FLAT WORKPIECE

(71) Applicant: SEWTS GMBH, MUENCHEN (DE)

(72) Inventors: ALEXANDER BLEY, MUENCHEN (DE); TIM DOERKS, MUENCHEN (DE); TILL RICKERT, MUENCHEN (DE)

(21) Appl. No.: 18/033,267

(22) PCT Filed: Oct. 20, 2021
(86) PCT No.: PCT/EP2021/079128

§ 371 Date: Apr. 21, 2023

(30) Foreign Application Priority Data
Oct. 22, 2020 (EP) 20203294.2

(51) Int. Cl. B25J 15/02; B25J 19/02; B25J 9/16; B25J 9/02; B25J 9/00

(52) U.S. Cl. CPC B25J 15/0253; B25J 19/023; B25J 9/1697; B25J 9/026; B25J 9/0087; B25J 9/123

(57) ABSTRACT

A positioning device for positioning a limp flat workpiece has a provisioning area for providing the flat workpiece to be positioned and a camera for generating a camera image of the flat workpiece to be positioned. Furthermore, the positioning device comprises a first manipulator having a first gripper, a second gripper and a third gripper. The second gripper and the third gripper are configured to take over at least a portion of the limp flat workpiece from the first gripper. In addition, a method of positioning a limp flat workpiece is presented.

The invention relates to a positioning device for positioning a limp flat workpiece.

Furthermore, the invention is directed to a method of positioning a limp flat workpiece.

In this context, a flat workpiece is understood to mean a workpiece which can assume a planar or sheet-like shape, i.e., for example, which has the form of a mat or a sheet or film. Such a workpiece is therefore significantly smaller in one of its dimensions than in the other two dimensions.

In this connection, limp workpieces are workpieces in which large deformations can be obtained by the action of comparatively small forces and/or moments. Limp workpieces are also referred to as dimensionally instable or dimensionally unstable.

Limp flat workpieces are found in numerous fields of industrial application. Examples include the manufacture of textiles, in particular garment textiles, industrial laundries, the production of covers and linings for vehicles and aircraft, and the manufacture of components made from fiber composites.

In the fields of application mentioned, a common problem here is that the limp flat workpieces have to be transferred from a random, in particular randomly or irregularly folded state to a defined position in order to be machined or machine-processed, for example. In most cases, this involves bringing the limp flat workpiece into a flat, spread-out position.

In many of the fields of application mentioned, it is common practice to manually transfer the flat workpieces to such a defined position.

Automated solutions for this are also known. These are usually based on the functional principle of multiple regripping. This means that the flat workpiece is gripped several times, in particular more than two times, at different points in order to transfer it to the desired position.

Against this background, it is the object of the invention to indicate a positioning device and a method of positioning a limp flat workpiece, by means of which a limp flat workpiece can be transferred to the desired final state in a simple, fast and reliable manner, irrespective of its random initial state.

The object is achieved by a positioning device for positioning a limp flat workpiece, which includes a provisioning area for providing the limp flat workpiece to be positioned. Furthermore, a camera is provided which is arranged and configured to generate a camera image of the limp flat workpiece which is to be positioned and which is located in the provisioning area. The positioning device further includes a first manipulator which carries a first gripper configured to grip at least a portion of the limp flat workpiece from the provisioning area. Furthermore, the positioning device is equipped with a second gripper and a third gripper. Here, the second gripper and the third gripper are each configured to take over at least a portion of the limp flat workpiece from the first gripper.

In a first alternative, the second gripper and the third gripper are drivingly coupled to a linear drive unit, so that the second gripper and the third gripper are each movable along the linear drive unit.

In a second alternative, the second gripper is carried by a second manipulator and the third gripper is carried by a third manipulator. The second and third manipulators may be industrial robots that cooperate with each other to handle the flat workpiece.

The designations “first”, “second” and “third” gripper as well as “first”, “second” and “third” manipulator are used only for unambiguous description and in particular do not imply a particular number of grippers or manipulators.

Moreover, the linear drive unit, to which the second and third grippers are drivingly connected in the first alternative, is separate from the first manipulator.

Using the provisioning area, limp flat workpieces that are to be positioned and that are available in a random, in particular irregularly folded state, can be provided for further processing in a simple manner. From there, the flat workpiece to be positioned is picked up by means of the first gripper, i.e. the first gripper grips a portion of the flat workpiece. For this purpose, an edge that can be gripped well by the first gripper can be identified by means of the camera, so that the first gripper can grip the flat workpiece from the provisioning area with high reliability and speed.

Subsequently, the flat workpiece can be transferred to the second gripper and the third gripper. Here, in particular, the second gripper and the third gripper are movable independently of each other along a direction of movement of the linear drive unit. In the alternative in which the second gripper and the third gripper are held at the second manipulator and the third manipulator, respectively, the grippers are substantially freely movable in space. In both alternatives, a flat workpiece gripped by means of the second gripper and the third gripper can be transferred to a flat spread-out position in a simple, fast and reliable manner.

The linear drive unit as well as the second manipulator and the third manipulator are also adapted, for example, to deposit the flat workpiece gripped by means of the second gripper and the third gripper in a defined manner and/or to place it in a downstream processing machine in a defined manner.

This means that the positioning device is generally designed such that the flat workpiece only has to be transferred one single time within the positioning device. In other words, only a single regripping process is performed. For one thing, this gives the positioning device a simple and compact structure. For another, in this way, flat workpieces can be transferred at high speed from a random initial state to a target state, which in particular corresponds to a flat spread-out state. In other words, such a positioning device is able to transfer limp flat workpieces to a target state with a short cycle time.

The flat workpieces are, e.g., towels, pillows, napkins, bed linen, incontinence pads or tablecloths. More generally speaking, the flat workpieces thus are flat linen or terry cloth goods.

In the present context, an edge of the flat workpiece is understood to mean a border of the flat workpiece, which may or may not be hemmed.

The linear drive unit, together with the second gripper and the third gripper, may be mounted in the positioning device so as to be rotatable about an axis extending parallel to its longitudinal extent. In particular, here the linear drive unit is mounted on a rack or frame of the positioning device.

The linear drive unit is significantly larger in one of its dimensions than in the other two. The direction of the longitudinal extent corresponds to this significantly larger dimension. Moreover, the longitudinal extent coincides with a direction of movement of the linear drive unit, that is, the direction along which the second gripper and the third gripper are movable. For simplification, the linear drive unit may also be referred to as a linear motion slide, since it can be used to linearly move the second gripper and the third gripper. Due to the linear drive unit being mounted for rotation, for taking over the flat workpiece from the first gripper, the second gripper and the third gripper can therefore be oriented with respect to the flat workpiece in such a way that the latter can be gripped reliably. Furthermore, the rotatable mounting can be made use of to adapt, in the course of depositing the flat workpiece, the position of the second gripper and the third gripper to an orientation of a base or a machine section on which the flat workpiece is to be deposited. The flat workpiece can thus be positioned particularly precisely and reliably. In addition, the flat workpiece can be deposited while the linear drive unit rotates together with the second gripper and the third gripper. This results in a particularly gentle and crease-free or at least low-crease depositing of the flat workpiece. The same result can of course also be achieved if the second gripper is held by the second manipulator and the third gripper is held by the third manipulator. The second manipulator and the third manipulator then move the second gripper and the third gripper into the orientations described above.

In an alternative, the provisioning area comprises a manipulation surface for providing the limp flat workpiece. Thus, the flat workpiece is provided in a random state on the manipulation surface. In this connection, the camera is arranged and configured to generate a camera image of the flat workpiece provided on the manipulation surface. In this way, comparatively constant boundary conditions are established for generating the camera image and for picking up the flat workpiece by means of the first gripper. As a result, the positioning device operates with high reliability.

The positioning device may also comprise a drop distance for the flat workpiece. The flat workpiece is then dropped along this drop distance before it is made available on the manipulation surface. In particular, the flat workpiece drops directly onto the manipulation surface. As the flat workpiece drops along the drop distance, it is spread out at least to a certain degree, so that the area covered by the flat workpiece on the manipulation surface is enlarged compared to a variant without a drop distance. This allows the flat workpiece to be picked up comparatively easily by means of the first gripper.

In one variant, the drop distance is delimited at least in sections by a ventilation unit that comprises a plurality of outflow openings. A flat workpiece moving along the drop distance can thus move counter to an airflow generated by the ventilation unit. Compared to the variant without a ventilation unit, the flat workpiece is thereby spread out at least to a certain extent, i.e. the area occupied by the flat workpiece on the manipulation surface is increased. This allows the flat workpiece to be picked up particularly easily by means of the first gripper.

In a first alternative, the plurality of outflow openings is provided at a ventilation surface. The ventilation surface extends substantially horizontally and coincides with the manipulation surface. In other words, the manipulation surface has outflow openings provided therein that produce an airflow that is directed substantially vertically upward. The flat workpiece drops onto the manipulation surface counter to this airflow. As a result, it can be picked up by the first gripper with a high degree of reliability. In addition, such a positioning device has a compact design.

In a second alternative, the plurality of outflow openings is provided at a ventilation surface that is inclined at an angle of less than 90 degrees in relation to a horizontal plane. The manipulation surface adjoins a lower edge of the ventilation surface. That is, the flat workpiece is dropped above the ventilation surface and then slides from the ventilation surface onto the manipulation surface. In this way, too, the flat workpiece can be made available on the manipulation surface in such a way that it can be reliably picked up by means of the first gripper.

Alternatively or additionally, the provisioning area comprises a provisioning container in which one or more limp flat workpieces can be provided.

In a first variant, the provisioning area thus comprises a provisioning container but no manipulation surface. In this case, the first gripper picks up the flat workpiece directly from the provisioning container. In the event that a plurality of flat workpieces is located in the provisioning container, an individualization also takes place in the process, i.e. only one flat workpiece is gripped from the provisioning container. The camera is arranged and configured to generate a camera image of the flat workpiece that is located in the provisioning container. A positioning device according to this variant is structurally simple in construction and, in particular, compact.

In a second variant, the provisioning area comprises both a provisioning container and a manipulation surface. In this variant, a flat workpiece to be positioned is first transferred from the provisioning container to the manipulation surface. In this connection, a plurality of limp flat workpieces may be present in the provisioning container, so that an individualization also has to take place. In that case, the camera is configured and arranged to generate a camera image of the flat workpiece present on the manipulation surface. Likewise, the first gripper is configured to grip the flat workpiece from the manipulation surface. In this variant, the same effects and advantages are obtained as have already been discussed with respect to the manipulation surface.

According to one embodiment, the positioning device includes a provisioning manipulator having a provisioning gripper, the provisioning manipulator being adapted to transfer flat workpieces provided by the provisioning container onto the manipulation surface. In particular, the provisioning manipulator and the provisioning gripper operate fully automatically, allowing the flat workpiece to be transferred directly onto the manipulation surface. Alternatively, it is transferred to the manipulation surface via a drop distance already described or via a conveyor, for example a conveyor belt. In all variants, the flat workpiece is provided such that it can be gripped quickly and reliably by the first gripper.

According to one variant, the first gripper comprises two pairs of gripper jaws, with a free space being provided between the two pairs of gripper jaws.

A pair of gripper jaws here denotes a total of two gripper jaws that interact with each other to grip the flat workpiece, i.e. can clamp the flat workpiece between them. The gripper jaws forming a pair of gripper jaws are thus variable with regard to their distance in order to be able to perform gripping operations. The first gripper comprises two such pairs of gripper jaws.

Preferably, the respective upper and the respective lower gripper jaws of the two pairs of gripper jaws are rigidly connected to each other, i.e. the respective upper and the respective lower gripper jaws can only be moved jointly. As a result, only a single drive may be provided for actuating the two pairs of gripper jaws.

The first gripper thus has a simple structural design and can be manufactured cost-effectively. At the same time, the flat workpiece can be gripped reliably in this way.

Furthermore, the first gripper may have a sensor provided thereon that monitors the free space to detect whether a flat workpiece has been gripped by means of the first gripper. This sensor is preferably an optical sensor.

The free space between the two pairs of gripper jaws gives the first gripper the shape of a fork with two prongs, each prong being formed by a pair of gripper jaws.

In this context, the free space may be dimensioned such that it can receive at least a portion of the second gripper and at least a portion of the third gripper when the second gripper and the third gripper are arranged at a minimum distance and/or in their initial positions. Here, an initial position of the second gripper and the third gripper corresponds to that position of the two grippers in which they take over the flat workpiece from the first gripper.

In particular, the second gripper and the third gripper are positioned as close as possible to each other by means of the linear drive unit or by means of the second manipulator and the third manipulator, i.e. arranged at a minimum distance.

In other words, the fork-shaped first gripper is designed such that the second gripper and the third gripper can move in between the two prongs of the fork to take over the flat workpiece. This results in a particularly reliable and low-error transfer of the flat workpiece from the first gripper to the second gripper and the third gripper.

According to one embodiment, a control unit is provided which comprises a first machine learning module which is adapted to identify a grippable edge of the limp flat workpiece on the basis of a camera image, generated by the camera, of the flat workpiece. Alternatively or additionally, the control unit comprises a second machine learning module which is adapted to determine a gripping point for the first gripper on the basis of a camera image, generated by the camera, of the limp flat workpiece. Alternatively or additionally, the control unit comprises a third machine learning module which is adapted to identify a type of the limp flat workpiece on the basis of a camera image, generated by the camera, of the limp flat workpiece.

Preferably, each of the machine learning modules comprises a trained artificial neural network. In this way, a grippable edge of the flat workpiece and/or a gripping point located on the grippable edge for the first gripper and/or a type of the limp flat workpiece can be identified in a simple and reliable manner.

In particular, the type of the limp flat workpiece is identified from a plurality of predefined types. If the type of flat workpiece is known, the identification of the grippable edge and determination of the gripping point as well as further processing steps can be geared towards this specific type. The flat workpiece can therefore be positioned with high speed and reliability.

For the application case of a large-scale laundry, the predefined types may include small towels, large towels, pillows, napkins, bed linen, incontinence pads and tablecloths.

In an alternative, the identification of the type of flat workpiece can also be utilized only to distinguish processable flat workpieces from non-processable flat workpieces. When a non-processable type of flat workpiece is detected, the associated flat workpiece is removed from the manipulation surface or the process is otherwise aborted or canceled.

Alternatively or additionally, the control unit comprises a fourth machine learning module that is adapted to identify a material of the limp flat workpiece based on a camera image, generated by the camera, of the limp flat workpiece.

Preferably, the fourth machine learning module also comprises a trained artificial neural network. In this way, a material of the limp flat workpiece can be identified in a simple and reliable manner.

Here, the material of the limp flat workpiece is identified in particular from a plurality of predefined materials or groups of materials. In an alternative, the identification of the material of the flat workpiece can also be used only to distinguish flat workpieces made from a material to be processed, e.g. terry cloth, from flat workpieces not to be processed, which are made, e.g., from materials other than terry cloth. When a flat workpiece is detected that is made from a material not to be processed, the flat workpiece is removed from the positioning device or processing thereof is otherwise discontinued.

In addition, the object is achieved by a method of positioning a limp flat workpiece, which is carried out in particular by means of a positioning device according to the invention, the method including the steps of:
a) providing the flat workpiece in a provisioning area, the flat workpiece assuming a random state;
b) gripping an edge of the flat workpiece by means of a first gripper;
c) transferring the flat workpiece from the first gripper to a second gripper and a third gripper so that the second gripper and the third gripper grip the edge of the flat workpiece; and
d) depositing the flat workpiece in a flat condition by means of the second gripper and the third gripper.

The random state here is in particular a randomly folded state. Moreover, it should be appreciated that the edge that is gripped by the first gripper has to be a grippable edge. Otherwise, the gripper would not be able to grip it.

As already discussed in connection with the positioning device according to the invention, the flat workpiece may be provided on a manipulation surface or in a provisioning container.

Proceeding from this, the flat workpiece can thus be deposited in a flat condition using a single regripping operation by means of the second gripper and the third gripper. This means that the method comprises only a few steps relating to the handling of the flat workpiece and is therefore simple. Moreover, this allows it to proceed at high speed. Preferably, the method proceeds in an automated fashion.

According to one variant, a camera image which shows the flat workpiece located in the provisioning area is generated by a camera. The camera image is transmitted to a first machine learning module of the control unit, and the first machine learning module identifies the position of the edge of the flat workpiece based on the camera image. The identified edge here corresponds to that edge at which the first gripper grips the flat workpiece. To determine the position of the edge, characteristic image features of the camera image in particular are extracted by means of the first machine learning module. For this purpose, the first machine learning module may include a trained artificial neural network. This network receives the camera image or partial images of the camera image for extracting characteristic image features. This allows a position of the edge of the flat workpiece to be identified comparatively quickly and with a high degree of reliability.

To identify the position of the edge, the camera image may be subdivided into a plurality of partial images. This is effected in particular by the control unit. For each partial image, characteristic image features are extracted by the first machine learning module of the control unit and, based on the characteristic image features, for each partial image a probability is established with which it shows an edge of the flat workpiece. In particular, for each partial image, probabilities are established with which it belongs to one of a plurality of predefined categories. The first machine learning module can therefore also be referred to as an image processing unit. Extracting the characteristic image features using such a machine learning module is performed quickly and reliably. In this way, a grippable edge can be identified quickly and reliably.

For the application in a textile laundry, in this connection the following categories can be used: “no edge”, “grippable edge”, “ungrippable edge”. This means that for each partial image the probabilities are established with which it belongs to the above-mentioned categories. A grippable edge is considered to have been identified when the partial image with the relatively highest probability has been found in the “grippable edge” category.

This artificial neural network used comprises, for example, between 10 and 180 layers. Particularly advantageous here are 34, 56 or 152 layers.

The camera image or at least a partial image of the camera image may be transmitted to a second machine learning module of the control unit. The second machine learning module then uses the camera image or the partial image of the camera image to identify a gripping point for the first gripper. Preferably, the gripping point for the first gripper is determined in a portion of the flat workpiece for the imaging of which in the camera image or in an associated partial image the relatively highest probability that the camera image or the partial image shows an edge has been established by means of the first machine learning module.

To determine the gripping point, characteristic image features of the camera image or of the partial image are again extracted, with gripping coordinates and a gripping orientation being calculated for the first gripper on the basis of the characteristic image features. To this end, the second machine learning module may include a trained artificial neural network. The gripping point may first be calculated in image coordinates and then transformed into the machine coordinates associated with the first gripper. In this way, a gripping point for the first gripper can be determined quickly and reliably.

The artificial neural network used in the second machine learning module likewise comprises, for example, between 10 and 180 layers.

In one embodiment, the second gripper and the third gripper substantially simultaneously grip a portion of the edge located in a free space between two gripper jaw pairs of the first gripper in order to transfer the flat workpiece from the first gripper to the second gripper and the third gripper. The portion of the edge located in the free space of the first gripper can therefore be gripped with particularly high reliability.

After the flat workpiece has been transferred to the second gripper and the third gripper, it is possible that the flat workpiece is held using the second gripper and the third gripper is moved away from the second gripper until the third gripper has reached a first corner of the flat workpiece. Alternatively, it is possible that after the flat workpiece has been transferred to the second gripper and the third gripper, the flat workpiece is held using the third gripper and the second gripper is moved away from the third gripper until the second gripper has reached a second corner of the flat workpiece. According to a further alternative, it is possible that after the flat workpiece has been transferred to the second gripper and the third gripper, the second gripper and the third gripper are simultaneously moved away from each other until the third gripper has reached a first corner of the flat workpiece and the second gripper has reached a second corner of the flat workpiece. Thus, at least one of the second gripper and the third gripper performs a relative movement with respect to the flat workpiece. It is also possible here that both the second gripper and the third gripper move relative to the flat workpiece. In all variants, the second gripper and the third gripper move away from each other along the direction of movement of the linear drive unit. In a simplified concept, one or both of the second and third grippers move(s) along the edge of the flat workpiece up to a corner. Of course, it has to be taken into account here that the actual movement of the second and/or third gripper is specified by the linear drive unit and the edge deforms accordingly. In this way, the flat workpiece can be simply and reliably transferred to a flat spread-out state.

According to one variant, for moving the second gripper away from the third gripper and/or for moving the third gripper away from the second gripper, a gripping force of the second gripper and/or of the third gripper is reduced compared to a predefined initial gripping state. Alternatively or additionally, for moving the second gripper away from the third gripper and/or for moving the third gripper away from the second gripper, the second gripper and/or the third gripper is/are opened by a specified amount. The flat workpiece is always gripped so firmly by the second gripper and the third gripper that it is reliably held by the respective gripper.

In other words, the flat workpiece is prevented from becoming separated from the second gripper and from the third gripper, for example by slipping out of the latter. At the same time, however, the flat workpiece is gripped by the second gripper and/or the third gripper only so firmly that a driving movement introduced by the linear drive unit into one or both grippers can result in a relative movement between the second gripper and/or the third gripper and the flat workpiece gripped. The flat workpiece can thus slide through the respective gripper without falling out.

In the case that the flat workpiece is provided on a manipulation surface, before generating the camera image a contact surface of the flat workpiece on the manipulation surface can be enlarged starting from the random state, in particular by moving the flat workpiece relative to an airflow, as has already been discussed in connection with the positioning device according to the invention. In this way, it is even easier to grip the flat workpiece by means of the first gripper.

According to an alternative, prior to identifying the grippable edge, a type of the flat workpiece can be identified by means of a third machine learning module of the control unit, in particular wherein the type of the flat workpiece is identified from a plurality of predefined types. The effects and advantages already discussed in connection with the positioning device are obtained.

In this context, the third machine learning module may include a trained artificial neural network that receives the camera image or partial images of the camera image for extracting characteristic image features.

All of the artificial neural networks described above are trained, for example, with freely available datasets in which images or partial images have been annotated depending on the task of the artificial neural network. The images or partial images used for training purposes thus originate from free sources. They were additionally allocated to the categories predefined for resolving the task of the respective artificial neural network. In particular, a dataset of the ImageNet project of Stanford and Princeton University (available at www.image-net.org) may be used for this purpose. Alternatively or additionally, it is possible to train the neural networks with, for example, 1000 to 5000 images per class, that is, per type or category to be recognized. Optionally, the artificial neural networks trained using freely available datasets are subsequently trained with the aid of proprietary datasets.

In this context, all of the artificial neural networks may be convolutional neural networks. A convolutional neural network is particularly well suited for the tasks described above. Here, the architecture of the artificial neural networks is based on the architecture described in the article “Deep Residual Learning for Image Recognition” by K. He, X. Zhang, S. Ren and J. Sun, which was published in the context of the 2016 IEEE Conference on Computer Vision and Pattern Recognition. Here, the last layer of the artificial neural network was always adapted to the respective specific task.

Apart from that, the effects and advantages already discussed with respect to the positioning device according to the invention also apply to the method according to the invention, and vice versa.

The invention will be discussed below with reference to various exemplary embodiments which are shown in the accompanying drawings, in which:

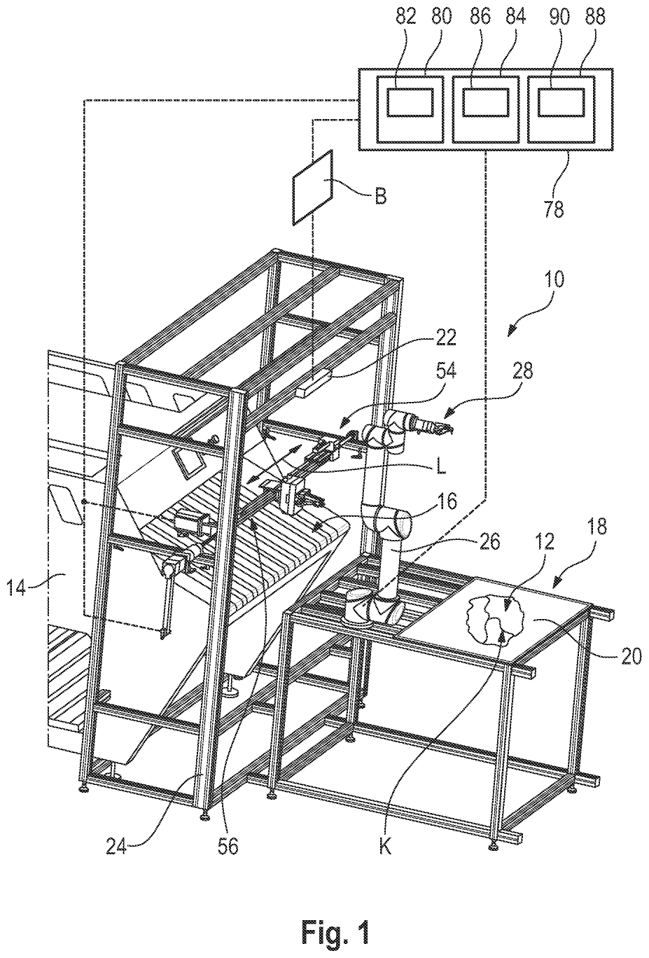

FIG. 1 shows a positioning device according to the invention in accordance with a first embodiment, by means of which a method according to the invention for positioning a limp flat workpiece can be carried out, as well as a further processing machine and a flat workpiece to be positioned;

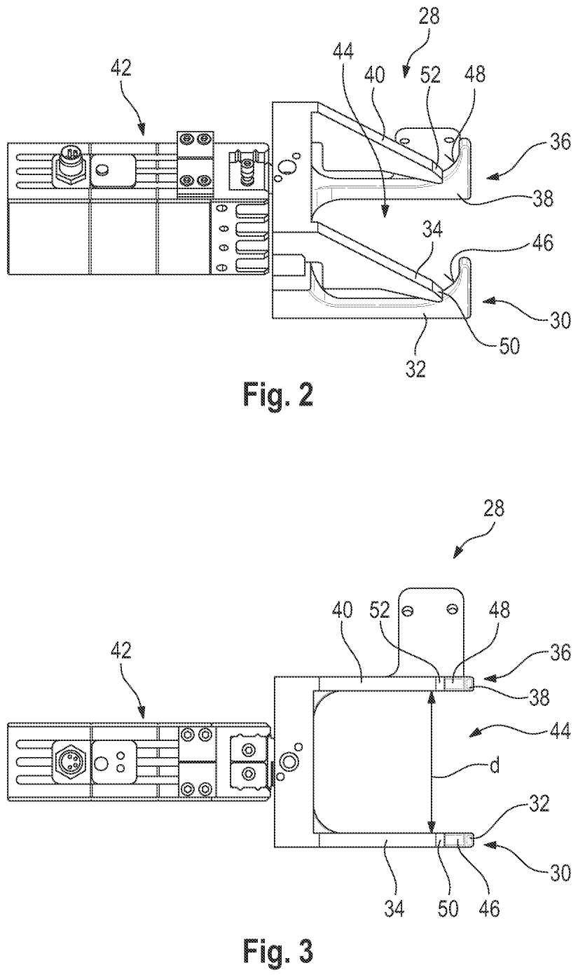

FIG. 2 shows a first gripper of the positioning device from FIG. 1 in an isolated, perspective illustration;

FIG. 3 shows the first gripper from FIG. 2 in a top view;

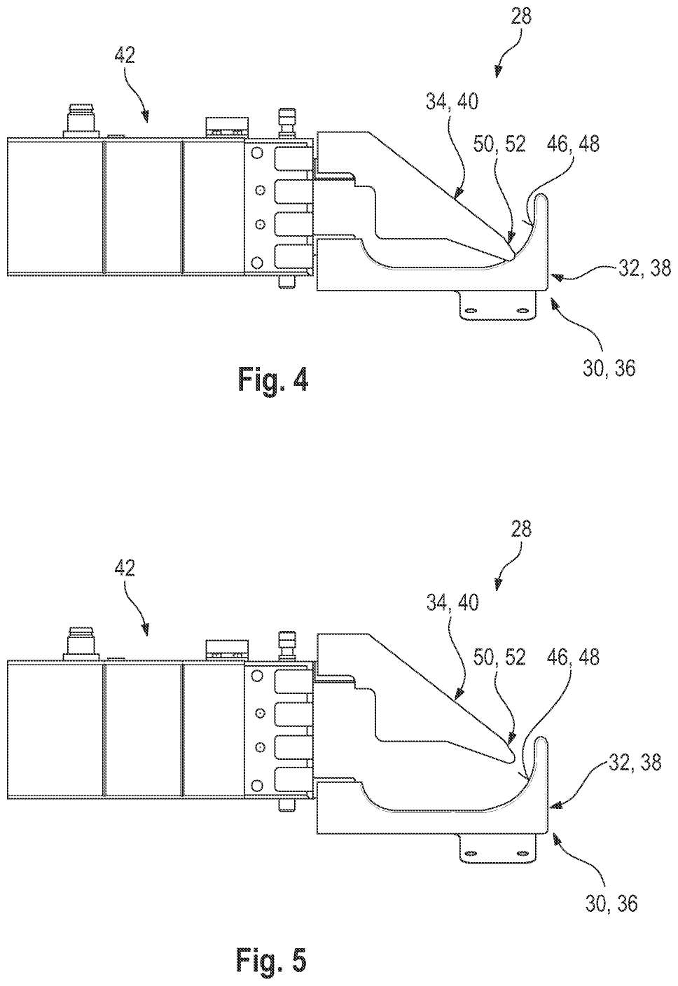

FIG. 4 shows the first gripper from FIG. 2 in a side view;

FIG. 5 shows the first gripper from FIGS. 2 to 4 in a side view corresponding to FIG. 4, with the first gripper being open;

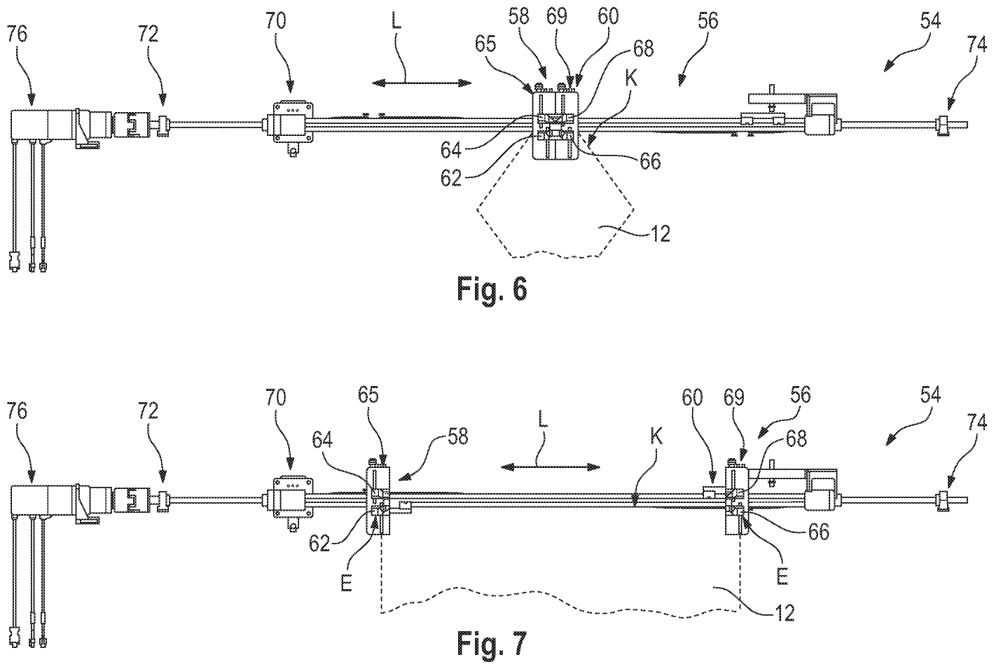

FIG. 6 shows a handling assembly of the positioning device from FIG. 1, which comprises a second gripper and a third gripper, in an isolated representation, with the flat workpiece being gripped by the second gripper and the third gripper;

FIG. 7 shows the handling assembly from FIG. 6, with the second gripper and the third gripper each assuming a different position and further with the flat workpiece being gripped by the second gripper and the third gripper;

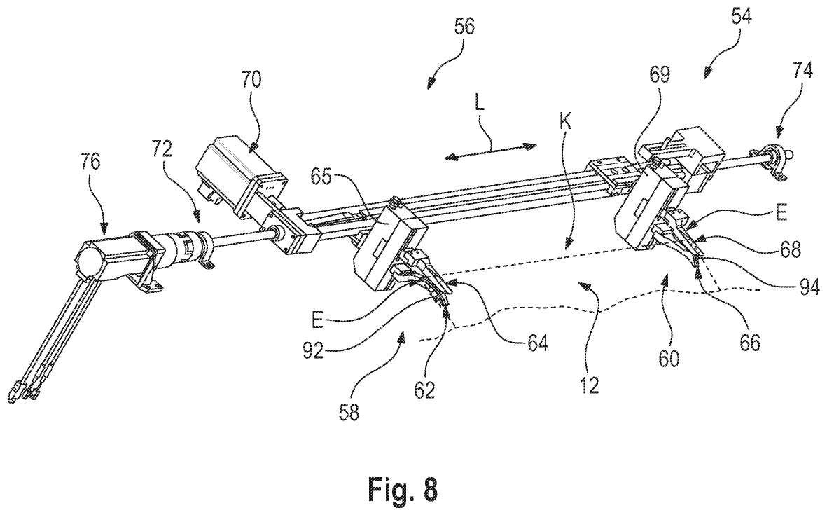

FIG. 8 shows the handling assembly and the flat workpiece from FIG. 7 in a perspective illustration;

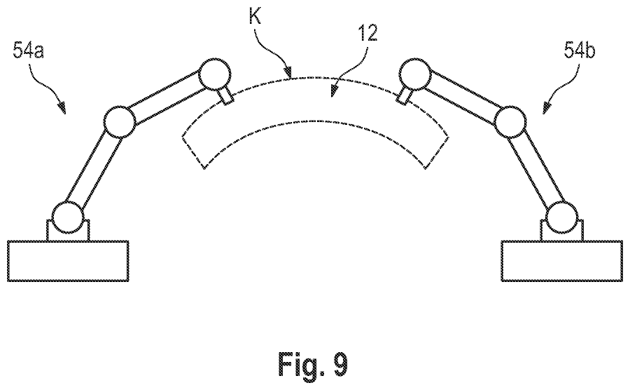

FIG. 9 shows an alternative to the handling assembly from FIGS. 6 to 8, with the flat piece being gripped again;

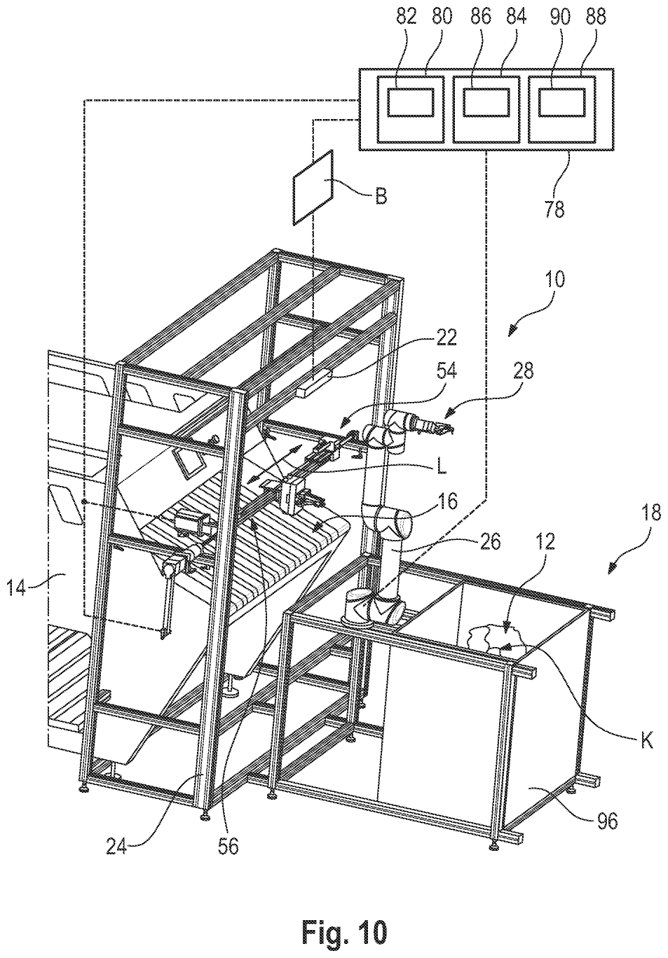

FIG. 10 shows a positioning device according to the invention in accordance with a second embodiment, by means of which a method according to the invention for positioning a limp flat workpiece can be carried out, as well as a further processing machine and a flat workpiece to be positioned;

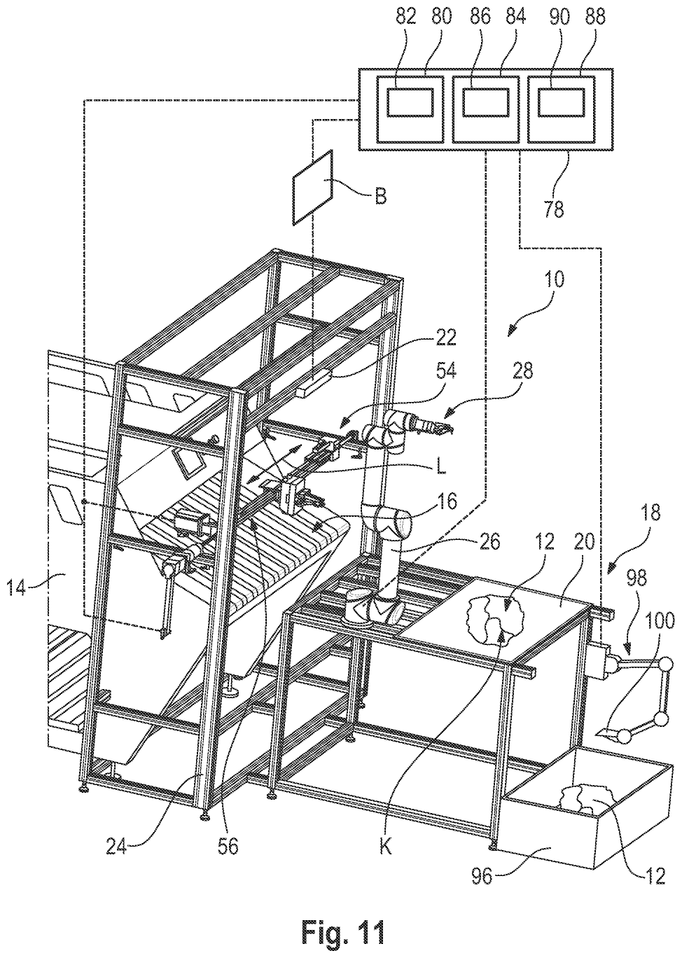

FIG. 11 shows a positioning device according to the invention in accordance with a third embodiment, by means of which a method according to the invention for positioning a limp flat workpiece can be carried out, as well as a further processing machine and two flat workpieces to be positioned;

FIG. 12 shows a schematic diagram for illustrating the invention; and

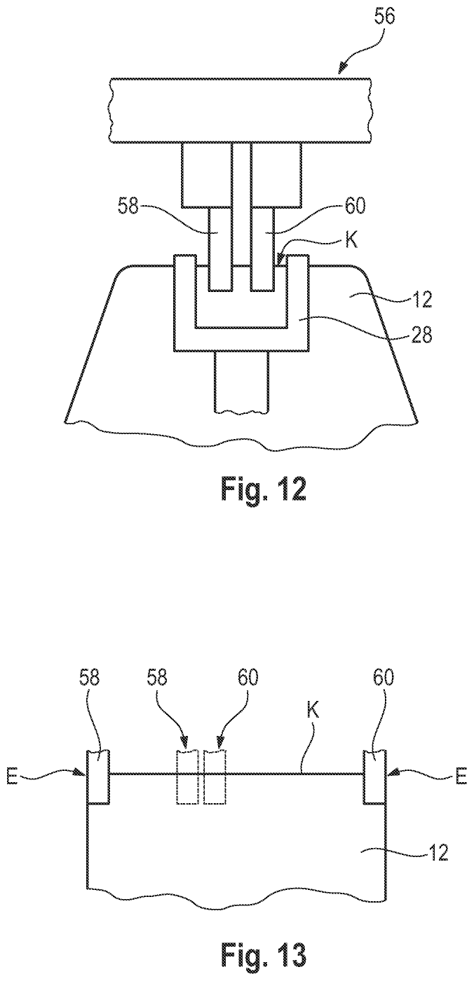

FIG. 13 shows a further schematic diagram for illustrating the invention.

FIG. 1 shows a positioning device 10 for positioning a limp flat workpiece 12.

In the embodiment shown, the positioning device 10 is configured to place the limp flat workpiece 12, which is provided in a random state, into a further processing machine 14 in a flat spread-out state. More specifically, the limp flat workpiece 12 is placed in a flat spread-out state onto the belt conveyor 16 comprising a plurality of conveyor belts.

The limp flat workpiece 12 is, for example, a towel.

The positioning device 10 comprises a provisioning area 18 which, in the first embodiment according to FIG. 1, comprises a manipulation surface 20 for providing the limp flat workpiece 12.

Furthermore, the positioning device 10 includes a camera 22 which is positioned within the positioning device 10 and adapted to generate a camera image B of the flat workpiece 12 provided in the provisioning area 18, more specifically on the manipulation surface 20.

In the present case, the camera 22 is fastened in an area of a frame 24 of the positioning device 10 which is located above the manipulation surface 20 in the vertical direction. The manipulation surface 20 is fully within the detection field of the camera 22.

The positioning device 10 further comprises a first manipulator 26, which in the embodiment shown is in the form of an industrial robot.

The first manipulator 26 carries a first gripper 28.

The latter is configured to grip a portion of the limp flat workpiece 12 that is located in the provisioning area 18.

The first gripper 28 is illustrated in detail in FIGS. 2 to 5.

It comprises a first gripper jaw pair 30, which includes a lower gripper jaw 32 and an upper gripper jaw 34.

Furthermore, the first gripper 28 is equipped with a second gripper jaw pair 36.

The latter also comprises a lower gripper jaw 38 and an upper gripper jaw 40.

It should be appreciated here that, due to the fact that the gripper 28 is fastened to the first manipulator 26, it can assume almost any desired orientations in space. Thus, the indications “upper” and “lower” merely serve to simplify the designation of the gripper jaws 32, 34, 38, 40 and essentially refer to the orientation of the first gripper 28 as illustrated in FIG. 2.

The lower gripper jaws 32, 38 are rigidly connected to each other.

Likewise, the upper gripper jaws 34, 40 are rigidly connected to each other.

The first gripper 28 further comprises an actuator 42 configured to selectively lift the upper gripper jaws 34, 40 off the respectively associated lower gripper jaws 32, 38 or to move the upper gripper jaws 34, 40 closer to the lower gripper jaws 32, 38 (see in particular FIGS. 4 and 5 for comparison).

Furthermore, a free space 44 is provided between the gripper jaw pairs 30, 36 (see in particular FIG. 3). The gripper jaw pairs 30, 36 thus have a distance d from each other.

Moreover, for easy pick-up and retaining of the flat workpiece 12, the respective lower gripper jaws 32, 38 are each equipped with a curved retaining surface 46, 48 in the area of their tip.

The upper gripper jaws 34, 40 each include a holding tip 50, 52 for pressing the flat workpiece 12 against the lower gripper jaws 32, 38. In particular, the flat workpiece 12 is pressed against the retaining surfaces 46, 48.

The positioning device 10 further comprises a handling assembly 54.

The handling assembly 54 is shown in detail in FIGS. 6 to 8.

It comprises a linear drive unit 56 as well as a second gripper 58 and a third gripper 60.

The second gripper 58 and the third gripper 60 are drivingly coupled to the linear drive unit 56 here so that the second gripper 58 and the third gripper 60 are each movable along a direction of movement L of the linear drive unit 56.

The driving coupling of the grippers 58, 60 to the linear drive unit 56 is designed in such a way here that the second gripper 58 and the third gripper 60 can only be moved interdependently. In other words, the third gripper 60 is moved when the second gripper 58 is moved, and vice versa.

Furthermore, the second gripper 58 and the third gripper 60 are each adapted to take over a portion of the limp flat workpiece 12 from the first gripper 28.

For this purpose, the second gripper 58 includes a gripper jaw pair that comprises a first gripper jaw 62 and a second gripper jaw 64.

The first gripper jaw 62 and the second gripper jaw 64 can be moved relative to each other by means of an actuator 65 in order to selectively clamp the flat workpiece 12 between them or to release it.

The third gripper 60 likewise comprises a gripper jaw pair having a first gripper jaw 66 and a second gripper jaw 68.

Here, the first gripper jaw 66 and the second gripper jaw 68 can be moved relative to each other by means of an actuator 69 in order to selectively clamp the flat workpiece 12 between them or to release it.

An actuator 70 is provided for moving the second gripper 58 and the third gripper 60 along the direction of movement L.

Moreover, the handling assembly 54 is mounted for rotation on the frame 24.

Here, an axis of rotation is oriented parallel to the longitudinal extent of the handling assembly 54. That is, the axis of rotation is also parallel to the direction of movement L, which corresponds to the longitudinal extent.

For this purpose, the handling assembly is mounted on the frame 24 by means of a first rotary bearing 72 and a second rotary bearing 74.

Furthermore, a rotary drive 76 is provided, by means of which the handling assembly 54 can be rotated relative to the frame 24.

With regard to their distance and with regard to their rotational position, which results from the rotational position of the handling assembly 54, the second gripper 58 and the third gripper 60 can assume an initial position in which the grippers 58, 60 are positioned at a comparatively small distance, in particular a minimum distance, from each other (see in particular FIG. 6).

Starting therefrom, the second gripper 58 and the third gripper 60 can be moved away from each other and thus transferred to positions apart from each other (see FIGS. 7 and 8).

The initial positions of the second gripper 58 and the third gripper 60 are coordinated with the first gripper 28 here in such a way that, in this initial position, the second gripper 58 and the third gripper 60 can move into the free space 44 of the first gripper 28 at least in sections (see also FIG. 11).

In other words, the free space 44 is dimensioned such that it can accommodate at least a portion of the second gripper 58 and of the third gripper when the latter are in the initial position.

As an alternative to the handling assembly 54, the positioning device 10 may comprise a second manipulator 54a and a third manipulator 54b, the second manipulator 54a carrying the second gripper 58 and the third manipulator 54b carrying the third gripper 60 (see FIG. 9).

In the present case, the manipulators 54a, 54b are in the form of two independent industrial robots which, however, cooperate with each other to handle the flat workpiece 12.

Since the grippers 58, 60 can be positioned and oriented essentially freely in space by means of the manipulators 54a, 54b, they are not mounted for rotation, in contrast to the handling assembly 54.

Apart from that, reference may be made to the discussions regarding the handling assembly 54, which apply analogously to the alternative with the second manipulator 54a and the third manipulator 54b.

In particular, the grippers 58, 60 are identical in configuration to the alternative comprising the handling assembly 54.

For operating the positioning device 10, a control unit 78 is also provided (see FIG. 1).

The control unit comprises a first machine learning module 80, which is adapted to identify a grippable edge K of the limp flat workpiece 12 based on the camera image B, generated by the camera 22, of the flat workpiece 12.

To this end, the first machine learning module is equipped with a trained artificial neural network 82.

Furthermore, a second machine learning module 84 is provided, which is adapted to determine a gripping point for the first gripper 28 based on the camera image B, generated by the camera 22, of the limp flat workpiece 12. The gripping point includes a gripper position as well as a gripper orientation of the first gripper 28 and is located, in particular, in the region of the grippable edge K.

The second machine learning module 84 is also equipped with a trained artificial neural network 86.

In addition, a third machine learning module 88 is provided, which is adapted to identify a type of the limp flat workpiece 12 based on the camera image B, generated by the camera 22, of the limp flat workpiece 12.

The third machine learning module 88 likewise comprises a trained artificial neural network 90.

It is understood that the control unit 78 has to be coupled at least indirectly to each actuator and each sensor of the positioning device 10. In FIG. 1, for the sake of greater clarity, only some of these couplings are drawn in by dashed lines in an exemplary manner.

The functionality of the control unit 78 and of the positioning device 10 as a whole will be discussed below together with a method of positioning the limp flat workpiece 12.

The aim of the method is to transfer the limp flat workpiece 12 starting from a random, in particular irregularly folded, state to a flat spread-out state and to place it in the further processing machine 14.

In this process, the flat workpiece 12 is first provided in its random state on the manipulation surface 20.

In this state, a camera image B of the flat workpiece 12 is generated by the camera 22 and transmitted to the control unit 78.

The camera image B is then subdivided into partial images by the control unit 78.

The partial images are transmitted to the first machine learning module 80, in particular to the associated artificial neural network 82, which, by extracting characteristic image features for each partial image, establishes a probability with which it shows a grippable edge K of the flat workpiece 12.

More precisely, for each partial image a probability is established with which it belongs to one of the categories “no edge”, “grippable edge” and “ungrippable edge”. A grippable edge K is considered to have been established when the partial image with the relatively highest probability of the category “grippable edge” has been found.

In this way, the position of a grippable edge K of the flat workpiece 12 can be identified by means of the first machine learning module 80.

At least the partial image of the camera image B showing the edge K is furthermore transmitted to the second machine learning module 84.

By extracting characteristic image features of at least this partial image by means of the artificial neural network 86, the second machine learning module identifies a gripping point for the first gripper 28, which is located at the edge K identified by means of the first machine learning module 80.

Optionally, the camera image B is also transmitted to the third machine learning module 88. The artificial neural network 90 comprised by this machine learning module 88 can identify a type of the flat workpiece by extracting characteristic image features. In this way, for example, flat workpieces 12 that do not conform to a specified type can be identified and eliminated from the provisioning area 18.

In the present example, flat workpieces 12 other than towels can thus be detected and excluded from processing.

Subsequently, the identified grippable edge K of the flat workpiece 12 is gripped by means of the first gripper 28.

To this end, the respective lower gripper jaws 32, 38, which comprise the arcuate retaining surfaces 46, 48, are guided under the edge K to be gripped in a pivoting movement of the first gripper 28. In the position resulting from this movement, the flat workpiece 12 is then gripped by closing the gripper 28, i.e. by the respective upper gripper jaws 34, 40 approaching the lower gripper jaws 32, 38.

The flat workpiece 12, more precisely the portion of the grippable edge K located between the two gripper jaw pairs 30, 36, is then transferred to the second gripper 58 and the third gripper 60, which assume their initial positions for this purpose (see FIG. 6).

In the case that instead of the handling assembly 54, the positioning device comprises the second manipulator 54a and the third manipulator 54b, which carry the second gripper 58 and the third gripper 60, respectively, the second gripper 58 and the third gripper 60 are transferred to a position corresponding to that depicted in FIG. 6, by means of the manipulators 54a, 54b.

Using the first manipulator 26, the first gripper 28 together with the gripped flat workpiece 12 is positioned relative to the second gripper 58 and the third gripper such that the second gripper 58 and the third gripper 60 move substantially simultaneously into the free space 44 between the gripper jaw pairs 30, 36 (see FIG. 12).

Thereafter, the first gripper 28 is moved to a position spaced apart from the handling assembly 54 by means of the first manipulator 26.

Now the flat workpiece 12 has to be transferred to a flat spanned position.

For this purpose, a gripping force for both the second gripper 58 and the third gripper 60 is reduced in comparison to an initial gripping state, which corresponds to the gripping state in which these two grippers 58, 60 have taken over the flat workpiece 12 from the first gripper 28.

Here, the reduced gripping force is sufficiently large to continue to hold the flat workpiece 12 by means of the second gripper 58 and by means of the third gripper 60. This means that the flat workpiece 12 cannot slip out of these grippers 58, 60.

At the same time, however, the gripping force is sufficiently small so that a relative movement between the flat workpiece 12 and the grippers 58, 60 along the direction L is possible.

In this connection, both the second gripper 58 and the third gripper 60 are moved outward until both grippers 58, 60 arrive at a respectively allocated corner E of the flat workpiece 12 (see FIG. 13; starting position of the grippers 58, 60 shown in dashed lines).

For detecting the corners E, both grippers 58, 60 are equipped with an appropriate sensor, in particular an optical sensor 92, 94.

In this relative position of the second gripper 58 and the third gripper 60 with respect to the flat workpiece 12, in the positioning device 10 equipped with the handling assembly 54, the handling assembly 54 is pivoted by means of the rotary drive 76 toward the belt conveyor 16 and the flat workpiece 12 is deposited thereon in a flat condition by opening the grippers 58, 60, thus releasing the flat workpiece 12.

In the variant of the positioning device 10 which comprises the second manipulator 54a and the third manipulator 54b, a corresponding movement of the grippers 58, 60 is realized by means of the manipulators 54a, 54b in order to deposit the flat workpiece 12 in a planar state.

The above-described traversing movements of the grippers 58, 60 can be made easier if the gripped edge K of the flat workpiece 12 is provided with a hem comprising a thickened portion on the edge of the flat workpiece 12. Such a thickened portion prevents slipping out of the grippers 58, 60, but allows the grippers 58, 60 to be traversed relative to the edge K.

In one variant of the method, the grippers 58, 60 are not moved relative to the flat workpiece at the same time, but one after the other. That is, the flat workpiece 12 is first held by one of the grippers 58, 60 the gripping force of which is not reduced. The respective other gripper 58, 60 is then traversed by means of the linear drive unit 56 until it arrives at an associated corner E.

Then the flat workpiece 12 is held by means of the gripper 58, 60 which has arrived at the corner E and the gripping force of which is then no longer reduced. The other gripper 58, 60 is traversed accordingly until it arrives at the other corner E.

FIG. 10 illustrates a positioning device 10 according to a second embodiment.

In the following, only the differences from the first embodiment shown in FIGS. 1 to 9 will be discussed.

Moreover, identical or mutually corresponding elements of the positioning device 10 are provided with the same reference numbers.

In the second embodiment, the provisioning area 18 comprises a provisioning container 96 instead of the manipulation surface 20. One or more limp flat workpieces 12 are provided in this container, with only a single flat workpiece 12 being illustrated by way of example in FIG. 10.

In this case, the camera 22 is again adapted and arranged such that it can generate a camera image of the flat workpiece 12 in the provisioning container 96.

The method of positioning the limp flat workpiece 12 proceeds in the same way as in the first embodiment. This applies both to the variant involving the handling assembly 54 and to the variant involving the second manipulator 54a and the third manipulator 54b. The flat workpiece 12 is merely gripped from the provisioning container 96 rather than from the manipulation surface 20.

FIG. 11 shows a third embodiment of the positioning device 10. Only the differences from the first and second embodiments will be discussed here.

Identical or corresponding elements of the positioning device 10 are provided with the same reference numbers.

The provisioning area 18 of the positioning device 10 now comprises both a manipulation surface 20 and a provisioning container 96. In this regard, the third embodiment is a combination of the first embodiment and the second embodiment.

Further provided is a provisioning manipulator 98, which is shown only schematically in FIG. 11 and is in the form of an industrial robot.

A provisioning gripper 100 is fitted to the provisioning manipulator 98.

Here, a limp flat workpiece 12 is transferred from the provisioning container 96 onto the manipulation surface 20 by means of the provisioning manipulator 98 and the provisioning gripper 100. For this purpose, the provisioning manipulator 98 and the provisioning gripper 100 are coupled to the control unit 78.

Proceeding from a state in which the flat workpiece 12 lies on the manipulation surface 20, the method of positioning the limp flat workpiece 12 proceeds as in the first embodiment. Again, this applies to both variants of the first embodiment.

1. A positioning device for positioning a limp flat workpiece, comprising:
a provisioning area for providing the limp flat workpiece to be positioned;
a camera which is arranged and configured to generate a camera image of the limp flat workpiece which is positioned and which is located in the provisioning area;
a first manipulator which carries a first gripper configured to grip at least a portion of the limp flat workpiece from the provisioning area;
a second gripper; and
a third gripper,
wherein the second gripper and the third gripper are each configured to take over at least a portion of the limp flat workpiece from the first gripper, and wherein:
the second gripper and the third gripper are drivingly coupled to a linear drive unit, wherein the second gripper and the third gripper are each movable along the linear drive unit, or
the second gripper is carried by a second manipulator and the third gripper is carried by a third manipulator.

2. The positioning device according to claim 1, wherein the linear drive unit together with the second gripper and the third gripper is mounted in the positioning device so as to be rotatable about an axis extending parallel to its longitudinal extent.

3. The positioning device according to claim 1, wherein the provisioning area comprises a manipulation surface for providing the limp flat workpiece.

4. The positioning device according to claim 1, wherein the provisioning area comprises a provisioning container in which one or more limp flat workpieces can be provided.

5. The positioning device according to claim 3, wherein a provisioning manipulator has a provisioning gripper, wherein the provisioning manipulator is configured to transfer flat workpieces provided by a provisioning container onto the manipulation surface.

6. The positioning device according to claim 1, wherein the first gripper comprises two gripper jaw pairs, wherein a free space is provided between the two gripper jaw pairs.

7. The positioning device according to claim 6, wherein the free space is dimensioned such that it can receive at least a portion of the second gripper and at least a portion of the third gripper when the second gripper and the third gripper are arranged at a minimum distance and/or in their initial positions.

8. The positioning device according to claim 1, wherein a control unit is provided comprising at least one of:
a first machine learning module which is adapted to identify a grippable edge of the limp flat workpiece on a basis of the camera image, generated by the camera, of the flat workpiece, or
a second machine learning module which is adapted to determine a gripping point for the first gripper on the basis of the camera image, generated by the camera, of the limp flat workpiece, or
a third machine learning module which is adapted to identify a type of the limp flat workpiece on the basis of the camera image, generated by the camera, of the limp flat workpiece.

9. A method of positioning a limp flat workpiece using a positioning device, the method comprising the steps of:
a) providing the flat workpiece in a provisioning area, the flat workpiece assuming a random state;
b) gripping an edge of the flat workpiece using a first gripper;
c) transferring the flat workpiece from the first gripper to a second gripper and a third gripper wherein the second gripper and the third gripper grip the edge of the flat workpiece; and
d) depositing the flat workpiece in a flat condition using the second gripper and the third gripper.

10. The method according to claim 9, wherein
a camera image which shows the flat workpiece located in the provisioning area is generated by a camera;
the camera image is transmitted to a first machine learning module of the control unit; and
the first machine learning module identifies a position of the edge of the flat workpiece based on the camera image.

11. The method according to claim 10, wherein for identifying the position of the edge, the camera image is subdivided into a plurality of partial images by the control unit, and characteristic image features are extracted by the first machine learning module of the control unit for each partial image and, based on the characteristic image features, for each partial image a probability is established with which it shows the edge of the flat workpiece, wherein, for each partial image, probabilities are established with which it belongs to one of a plurality of predefined categories.

12. The method according to claim 10, wherein
the camera image or at least a partial image of the camera image is transmitted to a second machine learning module of the control unit, and
the second machine learning module identifies a gripping point for the first gripper on a basis of the camera image or the partial image of the camera image.

13. The method according to claim 9, wherein for transferring the flat workpiece from the first gripper to the second gripper and the third gripper, the second gripper and the third gripper substantially simultaneously grip a portion of the edge located in a free space between two gripper jaw pairs of the first gripper.

14. The method according to claim 9, wherein
after transferring the flat workpiece to the second gripper and the third gripper, the flat workpiece is held using the second gripper and the third gripper is moved away from the second gripper until the third gripper has reached a first corner of the flat workpiece, or
after transferring the flat workpiece to the second gripper and the third gripper, the flat workpiece is held using the third gripper and the second gripper is moved away from the third gripper until the second gripper has reached a second corner of the flat workpiece, or
after transferring the flat workpiece to the second gripper and the third gripper, the second gripper and the third gripper are simultaneously moved away from each other until the third gripper has reached a first corner of the flat workpiece and the second gripper has reached a second corner of the flat workpiece.

15. The method according to claim 14, wherein
for moving the second gripper away from the third gripper and/or for moving the third gripper away from the second gripper, a gripping force of the second gripper and/or of the third gripper is reduced compared with a predefined initial gripping state, or
for moving the second gripper away from the third gripper and/or for moving the third gripper away from the second gripper, the second gripper and/or the third gripper is/are opened by a specified amount.

16. The positioning device according to claim 2, wherein the provisioning area comprises a manipulation surface for providing the limp flat workpiece.

17. The positioning device according to claim 4, wherein a provisioning manipulator has a provisioning gripper, wherein the provisioning manipulator is configured to transfer flat workpieces provided by the provisioning container onto the manipulation surface.

18. The method according to claim 11, wherein
the camera image or at least a partial image of the camera image is transmitted to a second machine learning module of the control unit, and
the second machine learning module identifies a gripping point for the first gripper on a basis of the camera image or the partial image of the camera image.

19. The method according to claim 10, wherein for transferring the flat workpiece from the first gripper to the second gripper and the third gripper, the second gripper and the third gripper substantially simultaneously grip a portion of the edge located in a free space between two gripper jaw pairs of the first gripper.

20. The method according to claim 10, wherein
after transferring the flat workpiece to the second gripper and the third gripper, the flat workpiece is held using the second gripper and the third gripper is moved away from the second gripper until the third gripper has reached a first corner of the flat workpiece, or
after transferring the flat workpiece to the second gripper and the third gripper, the flat workpiece is held using the third gripper and the second gripper is moved away from the third gripper until the second gripper has reached a second corner of the flat workpiece, or
after transferring the flat workpiece to the second gripper and the third gripper, the second gripper and the third gripper are simultaneously moved away from each other until the third gripper has reached a first corner of the flat workpiece and the second gripper has reached a second corner of the flat workpiece.
